(19) United States
(12) Patent Application Publication
(10) Pub. No.: US 2017/0074802 A1
(43) Pub. Date: Mar. 16, 2017

(54) DEFECT INSPECTION METHOD AND DEFECT INSPECTION DEVICE

(71) Applicant: KABUSHIKI KAISHA TOSHIBA, Tokyo (JP)

(72) Inventor: Kosuke TAKAI, Yokohama (JP)

(21) Appl. No.: 15/069,356

(22) Filed: Mar. 14, 2016

(30) Foreign Application Priority Data
Sep. 11, 2015 (JP) 2015-179357

(51) Int. Cl. G01N 21/88; G01N 21/956

(52) U.S. Cl. CPC G01N 21/8806; G01N 21/956; G01N 2021/95676; G01N 2201/061; G01N 2201/105

(57) ABSTRACT

A defect inspection method according to an embodiment includes irradiating an EUV mask having a substrate, a first line-shaped portion, and a second line-shaped portion with deep ultraviolet radiation from a lower surface side of the substrate, and detecting reflection light of the deep ultraviolet radiation. The first line-shaped portion and the second line-shaped portion are provided on the substrate. The second line-shaped portion is spaced from the first line-shaped portion. The first line-shaped portion and the second line-shaped portion include a first layer containing the first material and a second layer containing the second material. The first layer and the second layer are stacked in the first line-shaped portion and the second line-shaped portion.

### CROSS-REFERENCE TO RELATED APPLICATIONS

This application is based upon and claims the benefit of priority from Japanese Patent Application No. 2015-179357, filed on Sep. 11, 2015; the entire contents of which are incorporated herein by reference.

### FIELD

Embodiments relate to a defect inspection method and a defect inspection device.

### BACKGROUND

In recent years, EUV (extreme ultraviolet radiation) lithography technique using EUV as exposure light has been developed with the miniaturization of integrated circuits. The wavelength of EUV is as short as approximately 13.5 nm (nanometers). Thus, the EUV lithography technique enables very fine processing. No substance has sufficiently high transmittance to EUV. Thus, an EUV mask of the reflection type is used for EUV lithography. On the other hand, use of EUV for defect inspection of an EUV mask significantly increases the inspection cost. Thus, inspection is typically performed using DUV (deep ultraviolet radiation) having a wavelength of approximately 200 nm.

### BRIEF DESCRIPTION OF THE DRAWINGS

FIG. 1A is a plan view showing an EUV mask of a first embodiment; FIG. 1B is a sectional view taken along line A-A′ of FIG. 1A;

FIG. 2A is a sectional view showing a pattern structure body of the EUV mask of the first embodiment; FIG. 2B is a sectional view showing a case where the EUV mask includes a film remaining defect;

FIG. 3 shows a defect inspection device according to the first embodiment;

FIG. 4A shows an upper side inspection in which the EUV mask is irradiated with DUV from the pattern structure body side; FIG. 4B is a graph showing a detection result where the horizontal axis represents a position and the vertical axis represents a detection intensity of DUV;

FIG. 5A is a graph showing a detection result where the horizontal axis represents a position and the vertical axis represents a detection intensity of DUV; FIG. 5B shows a lower side inspection in which the EUV mask is irradiated with DUV from a substrate side;

FIG. 6 shows a defect inspection method according to a second embodiment; and

FIGS. 7A and 7B show a defect inspection method according to the second embodiment, FIG. 7A shows a lower side inspection in which DUV is incident on a lower surface of a substrate in a normal direction, FIG. 7B shows a lower side oblique inspection in which DUV is incident on the lower surface of the substrate in a direction oblique to the normal.

### DETAILED DESCRIPTION

A defect inspection method according to an embodiment includes irradiating an EUV mask having a substrate, a first line-shaped portion, and a second line-shaped portion with deep ultraviolet radiation from a lower surface side of the substrate, and detecting reflection light of the deep ultraviolet radiation. The first line-shaped portion and the second line-shaped portion are provided on the substrate. The second line-shaped portion is spaced from the first line-shaped portion. The first line-shaped portion and the second line-shaped portion include a first layer containing a first material and a second layer containing a second material. The first layer and the second layer are stacked in the first line-shaped portion and the second line-shaped portion.

### First Embodiment

First, a first embodiment is described.

The embodiment relates to a defect inspection device and a defect inspection method for determining the presence or absence of defects in an EUV mask.

First, an EUV mask subjected to inspection In the embodiment is described.

The EUV mask is a lithography mask of the light reflection type. The EUV mask is used for lithography using EUV as exposure light to manufacture a fine structure body. The fine structure body includes e.g. an integrated circuit such as a substrate circuit of LSI (large scale integrated circuit), memory device, and display, a discrete semiconductor device such as MOSFET (metal-oxide-semiconductor field-effect transistor), IGBT (Insulated gate bipolar transistor), and LED (light emitting diode), and a fine mechanical device such as MEMS (microelectromechanical system).

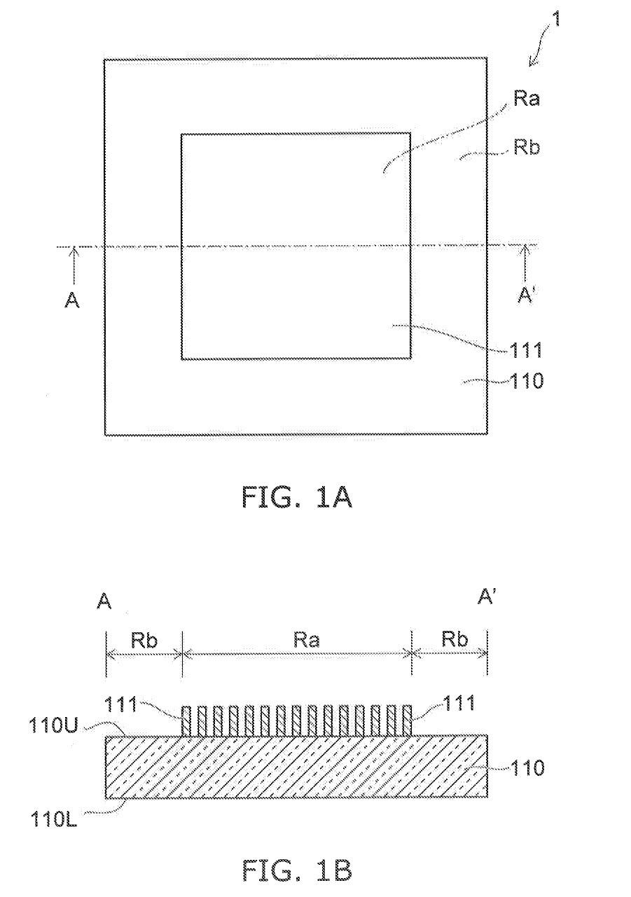

FIG. 1A is a plan view showing the EUV mask of the embodiment. FIG. 1B is a sectional view taken along line A-A′ of FIG. 1A.

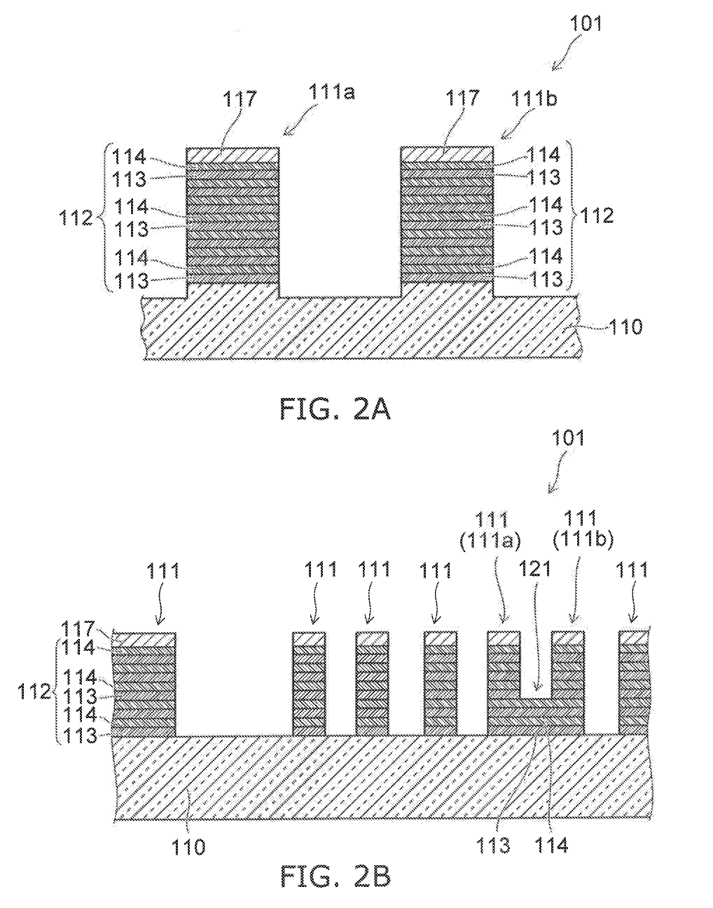

FIG. 2A is a sectional view showing a pattern structure body of the EUV mask of the embodiment. FIG. 2B is a sectional view showing the case where the EUV mask includes a film remaining defect.

The figures illustrated below are all schematic. The dimension ratio of each part is not necessarily to scale. Components existing In a large number are shown in a reduced number.

As shown in FIG. 1A, the EUV mask 101 subjected to inspection in the embodiment includes a substrate 110. The substrate 110 is made of a glass having very small thermal expansion coefficient such as LTEM (low thermal expansion material). The substrate 110 is shaped like e.g. a rectangular plate. As viewed from above, the length of one side of the substrate 110 is approximately 100-200 mm (millimeters). As viewed from above, an exposure region Ra is defined in the central part of the substrate 110. The exposure region Ra is shaped like e.g. a square. The length of one side of the exposure region Ra is several ten mm. A peripheral region Rb is defined in the peripheral part of the substrate 110. The peripheral region Rb is shaped like a frame surrounding the exposure region Ra.

As shown In FIG. 1B, in the exposure region Ra, a pattern structure body 111 is provided on the substrate 110. The pattern structure body 111 constitutes a to-be-processed pattern to be manufactured by EUV lithography technique using the EUV mask 101. For instance, the pattern corresponds to the circuit pattern of an integrated circuit. On the other hand, the pattern structure body 111 is not provided in the peripheral region Rb. However, the pattern structure body 111 may be provided also in the peripheral region Rb.

As shown in FIG. 2A, in the pattern structure body 111, a multilayer film 112 is provided on the substrate 110. Molybdenum layers 113 made of molybdenum (Mo) and silicon layers 114 made of silicon (SI) are alternately stacked in the multilayer film 112. The multilayer film 112 includes e.g. approximately 40 pairs of the molybdenum layer 113 and the silicon layer 114.

A capping layer 117 made of e.g. ruthenium (Ru) is provided on the multilayer film 112. The multilayer film 112 and the capping layer 117 constitute the pattern structure body 111. However, the pattern structure body 111 does not need to include the capping layer 117.

The pattern structure body 111 is patterned into an enlarged pattern of the to-be-processed pattern. The pattern structure body 111 includes at least two line-shaped portions 111a and 111b. Each of the line-shaped portions 111a and 111b is a portion extending in one direction parallel to the upper surface of the substrate 110. Each of the line-shaped portions 111a and 111b corresponds to one wiring in the to-be-processed pattern. Each of the line-shaped portions 111a and 111b Includes molybdenum layers 113 and silicon layers 114 alternately stacked therein. The portion of the substrate 110 between the pattern structure bodies 111 is slightly dug in.

Such an EUV mask 101 can be fabricated as follows, for instance. First, a blank substrate is fabricated. Specifically, approximately 40 pairs of the molybdenum layer 113 and the silicon layer 114 are alternately stacked by sputtering technique on a substrate 110 made of LTEM. Thus, a multilayer film 112 is formed. The multilayer film 112 is configured so that the silicon layer 114 is located at the surface. Next, a capping layer 117 is formed by depositing ruthenium. Next, a tantalum nitride layer (TaN layer, not shown) is formed. Then, a tantalum oxide layer (TaO layer, not shown) is formed. Thus, the blank substrate is fabricated.

Next, a chemically amplified positive resist film (not shown) is formed by coating technique on the blank substrate. A to-be-processed pattern is written with an electron beam on the resist film by an electron beam writer. Next, PEB (post-exposure bake) and development are performed to form a resist pattern. Next, the resist pattern is used as a mask to pattern the TaO layer and the TaN layer by plasma processing. Next, etching is performed using the patterned TaO layer and TaN layer as a hard mask to pattern the capping layer 117 and the multilayer film 112. Next, the TaO layer and the TaN layer are removed by plasma processing. Thus, the EUV mask 101 is fabricated.

In the EUV mask 101, no light absorber is provided on the pattern structure body 111. Thus, there is no shadowing effect in which the shadow of a light absorber produces an error between the pattern formed in the EUV mask 101 and the pattern formed on the wafer.

As shown in FIG. 2B, the EUV mask 101 may include a film remaining defect 121. The film remaining defect 121 is a defect in which at least a lower part of the multilayer film 112 remains between parts of the pattern structure body 111, e.g. between the line-shaped portion 111a and the line-shaped portion 111b. Thus, the film remaining defect 121 includes several molybdenum layers 113 and silicon layers 114 (at least one for each) stacked therein. The lower surface thereof is in contact with the substrate 110. For instance, the film remaining defect 121 occurs due to the presence of foreign matter on the multilayer film 112 when the multilayer film 112 is patterned by etching. Alternatively, the film remaining defect 121 occurs due to the presence of a defect such as “protrusion” in the original pattern.

The film remaining defect 121 includes molybdenum layers 113 and silicon layers 114 stacked therein, although only several layers. Thus, the film remaining defect 121 exhibits a certain reflectance to EUV. Accordingly, due to the presence of the film remaining defect 121, EUV is reflected in the region between the line-shaped portion 111a and the line-shaped portion 111b, i.e., in the region in which EUV should not be reflected. This results in significantly decreasing the optical contrast of the exposure pattern. Thus, a defect may occur in the fine structure body manufactured by the EUV mask 101.

Next, a defect inspection device according to the embodiment is described.

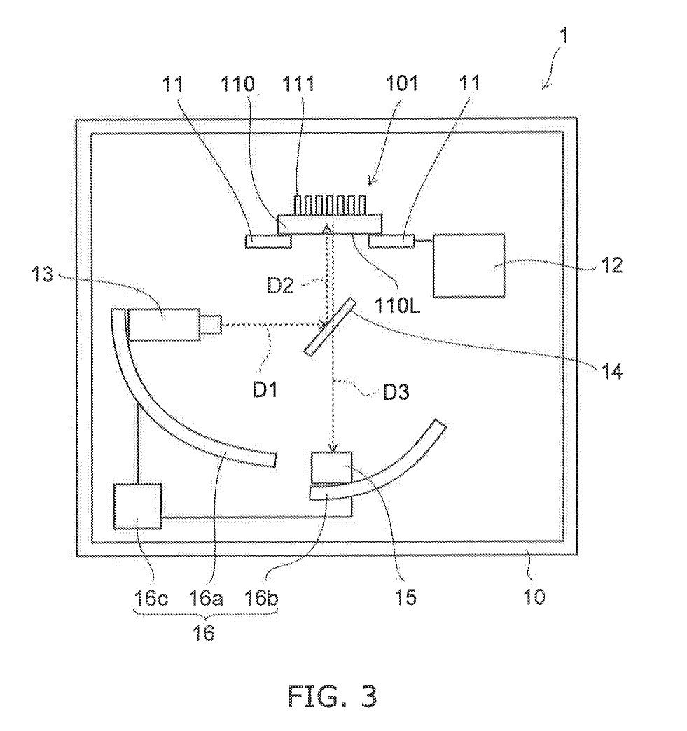

FIG. 3 shows the defect inspection device according to the embodiment.

As shown in FIG. 3, the defect inspection device 1 according to the embodiment includes a container 10. The container 10 includes a movable stage 11, an X-Y motor 12, a DUV laser light source 13, a DUV half mirror 14, a DUV detector 15, and a driving means 16 described below.

The movable stage 11 holds the EUV mask 101 subjected to inspection so as to expose a region of the lower surface 110L of the substrate 110 corresponding to at least the exposure region Ra (see FIG. 1B). The X-Y motor 12 moves the movable stage 11 along one plane, e.g. the horizontal plane. The DUV laser light source 13 emits DUV laser light D1 as inspection light. The DUV laser light D1 is e.g. ArF excimer laser light having a wavelength of 193 nm. The DUV half mirror 14 partly transmits and partly reflects the DUV laser light D1. The DUV detector 15 detects DUV. The driving means 16 includes a guide rail 16a for regulating the position and angle of the DUV laser light source 13, a guide rail 16b for regulating the position and angle of the DUV detector 15, and a controller 16c. The controller 16c moves the DUV laser light source 13 along the guide rail 16a and moves the DUV detector 15 along the guide rail 16b. Thus, the DUV laser light source 13 and the DUV detector 15 work in a ganged manner.

Next, the operation of the aforementioned defect inspection device 1, i.e., a defect inspection method according to the embodiment, is described.

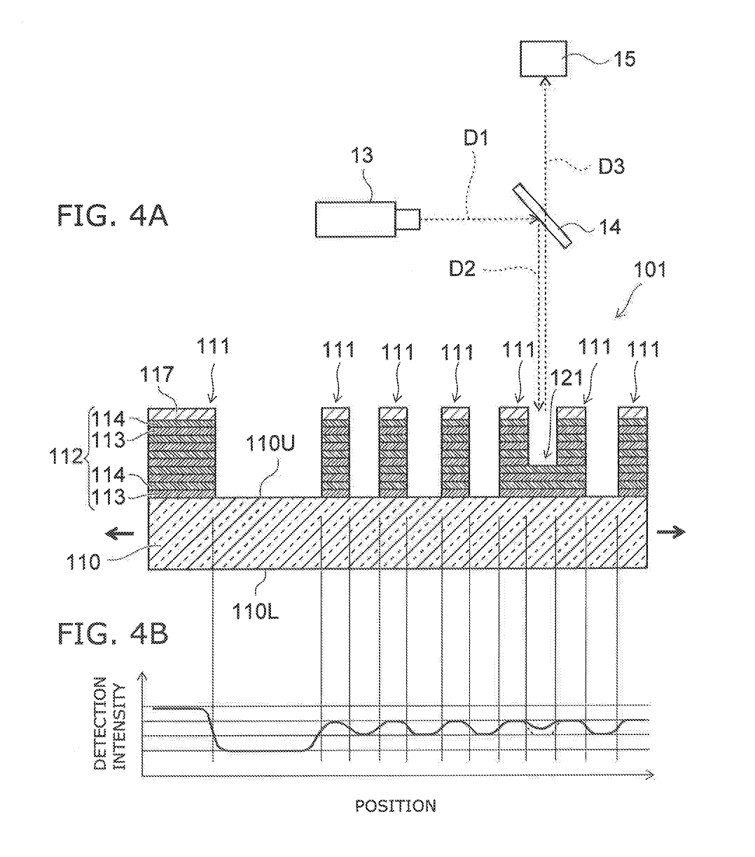

FIG. 4A shows an upper side inspection in which the EUV mask is irradiated with DUV from the pattern structure body side. FIG. 4B is a graph showing the detection result. In FIG. 4B, the horizontal axis represents the position, and the vertical axis represents the detection intensity of DUV.

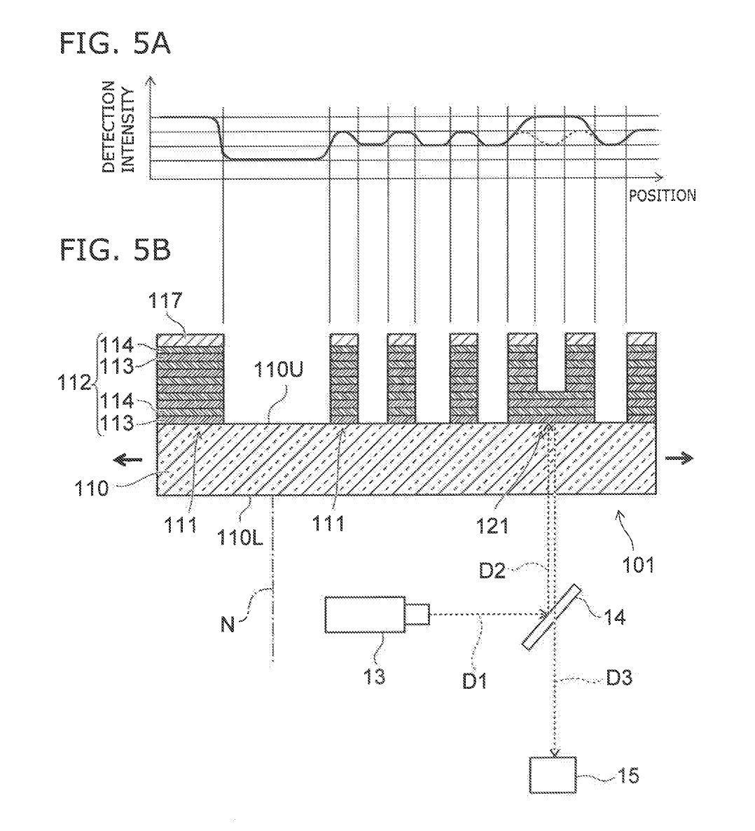

FIG. 5A is a graph showing the detection result. In FIG. 5A, the horizontal axis represents the position, and the vertical axis represents the detection intensity of DUV. FIG. 5B shows a lower side inspection in which the EUV mask is irradiated with DUV from the substrate side.

The position on the horizontal axis of FIG. 4B corresponds to the lateral position of the EUV mask shown in FIG. 4A. Likewise, the position on the horizontal axis of FIG. 5A corresponds to the lateral position of the EUV mask shown in FIG. 5B. The lateral direction of the EUV mask is one direction parallel to the lower surface 110L of the substrate 110. The solid line shown in FIGS. 4B and 5A represents a measurement profile In which there is a film remaining defect 121. The dashed line represents a reference profile in which there is no film remaining defect 121. The reference profile can be produced from the inspection result of another region in the EUV mask 101 or the design data of the EUV mask 101.

First, as shown in FIG. 3, the EUV mask 101 is mounted on the movable stage 11. At this time, the lower surface 110L of the substrate 110 is exposed at least in the exposure region Ra. Then, the X-Y motor 12 moves the movable stage 11 and places the EUV mask 101 at a prescribed inspection position. Furthermore, the container 10 is filled with a non-oxidizing atmosphere, e.g. nitrogen atmosphere.

<1> Inspection by DUV Irradiation from the Pattern Structure Body Side (Upper Side Inspection)

Then, as shown in FIGS. 4A and 4B, the EUV mask 101 is inspected by DUV irradiation from the pattern structure body 111 side. In this specification, this inspection is referred to as “upper side inspection”. At this time, the movable stage 11, the DUV laser light source 13, the DUV half mirror 14, and the DUV detector 15 are placed in a positional relationship satisfying the following requirements (1)-(4).

(1) The DUV laser light D1 emitted from the DUV laser light source 13 is incident on the DUV half mirror 14.

(2) The DUV half mirror 14 reflects the DUV laser light D1 as reflection light D2. The reflection light D2 Is incident from the pattern structure body 111 side on the EUV mask 101 held by the movable stage 11.

(3) The EUV mask 101 reflects the reflection light D2 as reflection light D3. The reflection light D3 is incident on the DUV half mirror 14.

(4) The reflection light D3 transmitted through the DUV half mirror 14 is incident on the DUV detector 15.

Such placement can be realized in the defect inspection device 1 shown in FIG. 3 as follows. For instance, the movable stage 11 holds the EUV mask 101 in a posture such that the pattern structure body 111 faces the DUV half mirror 14 side.

In this state, as shown in FIG. 4A, the DUV laser light source 13 emits DUV laser light D1. The DUV half mirror 14 is irradiated with the DUV laser light D1. Part of the DUV laser light D1 is reflected as reflection light D2. The reflection light D2 is incident on the EUV mask 101 from the pattern structure body 111 side. The reflection light D2 reaches the upper surface of the pattern structure body 111. Then, the reflection light D2 is reflected as reflection light D3 by the pattern structure body 111. Part of the reflection light D3 transmitted through the DUV half mirror 14 is detected by the DUV detector 15. If the reflection light D2 reaches a region between the pattern structure bodies 111 including no film remaining defect 121, then this reflection light D2 is not reflected, and not detected by the DUV detector 15. However, if the reflection light D2 reaches a region including a film remaining defect 121, then this reflection light D2 is reflected by the film remaining defect 121, and detected by the DUV detector 15.

Thus, as represented by the solid line in FIG. 4B, the measurement profile of the detection result has a shape corresponding to the placement of the pattern structure body 111 and the film remaining defect 121. However, the arrangement pitch of the pattern structure body 111 is several ten nm, and is finer than the wavelength of DUV. Thus, the profile is not shaped like a rectangular wave, but a gradual curve. The contrast, i.e. the amplitude of the profile, decreases with the decrease of the arrangement pitch of the pattern structure body 111. The film remaining defect 121 is detected by comparison between the measurement profile represented by the solid line and the reference profile represented by the dashed line in FIG. 4B.

However, the film remaining defect 121 is located at the bottom of the valley between the pattern structure bodies 111. Thus, the reflection light D2 Incident from above is not likely to reach the film remaining defect 121. Accordingly, the reflection light D3 reflected by the film remaining defect 121 is weaker, and more difficult to detect, than the reflection light D3 reflected by the pattern structure body 111. That is, the film remaining defect 121 is sensitive to EUV incident from above at the exposure time and Induces a defect. However, the film remaining defect 121 is insensitive to DUV incident from above at the inspection time, and detected less easily.

<2> Inspection by DUV Irradiation from the Substrate Side (Lower Side Inspection)

Next, as shown in FIGS. 5A and 5B, the EUV mask 101 is inspected by DUV irradiation from the substrate 110 side. In this specification, this inspection is referred to as “lower side inspection”.

In the lower side inspection, as shown in FIG. 5B, the controller 16c drives the guide rails 16a and 16b to control the position of the DUV laser light source 13 and the DUV detector 15. Thus, the movable stage 11, the DUV laser light source 13, the DUV half mirror 14, and the DUV detector 15 are placed in a positional relationship satisfying the following requirements (1), (5), (3), and (4).

(1) The DUV laser light D1 emitted from the DUV laser light source 13 is incident on the DUV half mirror 14.

(5) The DUV half mirror 14 reflects the DUV laser light D1 as reflection light D2. The reflection light D2 is incident from the side of the lower surface 110L of the substrate 110 on the EUV mask 101 held by the movable stage 11.

(3) The EUV mask 101 reflects the reflection light D2 as reflection light D3. The reflection light D3 is incident on the DUV half mirror 14.

(4) The reflection light D3 transmitted through the DUV half mirror 14 is incident on the DUV detector 15.

In this state, the DUV laser light source 13 emits DUV laser light D1. The DUV half mirror 14 is irradiated with the DUV laser light D1. Part of the DUV laser light D1 is reflected as reflection light D2. The reflection light D2 reaches the lower surface 110L of the substrate 110 of the EUV mask 101. At this time, the reflection light D2 is incident on the lower surface 110L from a direction generally parallel to the normal N of the lower surface 110L. The reflection light D2 Injected from the lower surface 110L into the substrate 110 is transmitted in the substrate 110 and reaches the upper surface 110U of the substrate 110.

If the reflection light D2 reaches a region of the upper surface 110U in contact with the pattern structure body 111 or the film remaining defect 121, then the reflection light D2 is reflected as reflection light D3 by the pattern structure body 111 or the film remaining defect 121. The reflection light D3 is transmitted again in the substrate 110 and emitted from the lower surface 110L to the outside of the substrate 110. The reflection light D3 travels in a direction generally parallel to the normal N of the lower surface 110L and reaches the DUV half mirror 14. Part of the reflection light D3 is transmitted through the DUV half mirror 14, incident on the DUV detector 15, and detected.

On the other hand, if the reflection light D2 reaches a region of the upper surface 110U of the substrate 110 not in contact with any of the pattern structure body 111 and the film remaining defect 121, then the reflection light D2 is emitted from the upper surface 110U to the outside of the substrate 110, and not detected by the DUV detector 15.

The detection intensity by the DUV detector 15 is plotted with respect to the lateral position of the EUV mask 101. This forms a profile corresponding to the placement distribution of the pattern structure body 111 and the film remaining defect 121 as represented by the solid line in FIG. 5A. Thus, the film remaining defect 121 can be detected by comparison between the measurement profile represented by the solid line and the reference profile represented by the dashed line in FIG. 5A.

The lower surface of the film remaining defect 121 is located at the same height as the lower surface of the pattern structure body 111. Thus, as viewed from the substrate 110 side, the film remaining defect 121 is located as forward as the pattern structure body 111. Accordingly, the reflection light D2 is likely to reach the film remaining defect 121. The intensity of the reflection light D3 reflected by the film remaining defect 121 is comparable with the intensity of the reflection light D3 reflected by the pattern structure body 111. Thus, the film remaining defect 121 can be detected with high sensitivity.

In particular, there may be a film remaining defect 121 connecting parts of the pattern structure body 111, e.g., the line-shaped portion 111a and the line-shaped portion 111b. In this case, the line-shaped portion 111a, the film remaining defect 121, and the line-shaped portion 111b placed continuously form a large reflection surface. This increases the intensity of the reflection light D3. Thus, the reflection light D3 is detected more easily. Accordingly, when the EUV mask 101 is irradiated with DUV from the substrate 110 side, the film remaining defect 121 can be detected with high accuracy.

The film remaining defect 121 thus detected is removed by e.g. an EB repair tool. Then, a conductive film is formed on the lower surface 110L of the substrate 110. This conductive film is needed to fix the EUV mask 101 in the exposure device by an electrostatic chuck. This conductive film may be formed from a material opaque to DUV such as chromium nitride (CrN). In this case, the conductive film is preferably formed after the aforementioned defect inspection. On the other hand, the conductive film may be formed from a transparent and conductive material such as ITO (Indium tin oxide, tin-doped indium oxide). In this case, the conductive film may be formed before the aforementioned defect inspection.

Next, the effect of the embodiment is described.

As described above, the film remaining defect 121 of the EUV mask 101 is located at the bottom of the valley between the pattern structure bodies 111, i.e. on the substrate 110 side. This makes it difficult to detect the film remaining defect 121 with high accuracy by the upper side inspection.

Thus, in the embodiment, the lower side inspection is performed in the process shown in FIGS. 5A and 5B. In the lower side inspection, the EUV mask 101 is irradiated with DUV from the substrate 110 side. Thus, the film remaining defect 121 can be detected with high sensitivity. As a result, pattern defects are reduced in the exposure of a wafer using this EUV mask 101. This can improve the yield of the fine structure body.

In the embodiment, the upper side inspection and the lower side inspection are both performed. The results of these inspections can be integrated to reinforce the inspection result. For instance, foreign matter attached to the upper surface of the pattern structure body 111 can be reliably detected by the upper side inspection.

### Second Embodiment

Next, a second embodiment is described.

The configuration of the defect inspection device according to the embodiment is similar to that of the above first embodiment.

Next, a defect inspection method according to the embodiment is described.

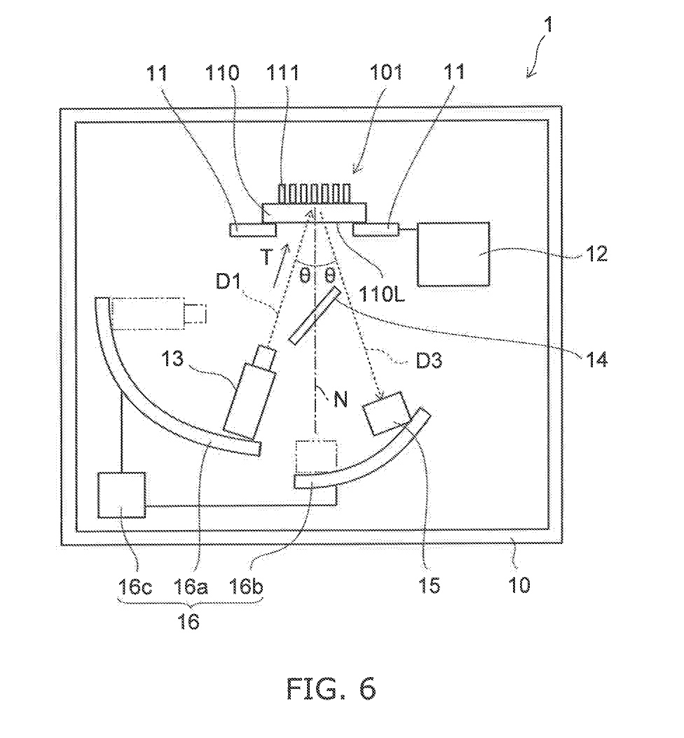

FIG. 6 shows the defect inspection method according to the embodiment.

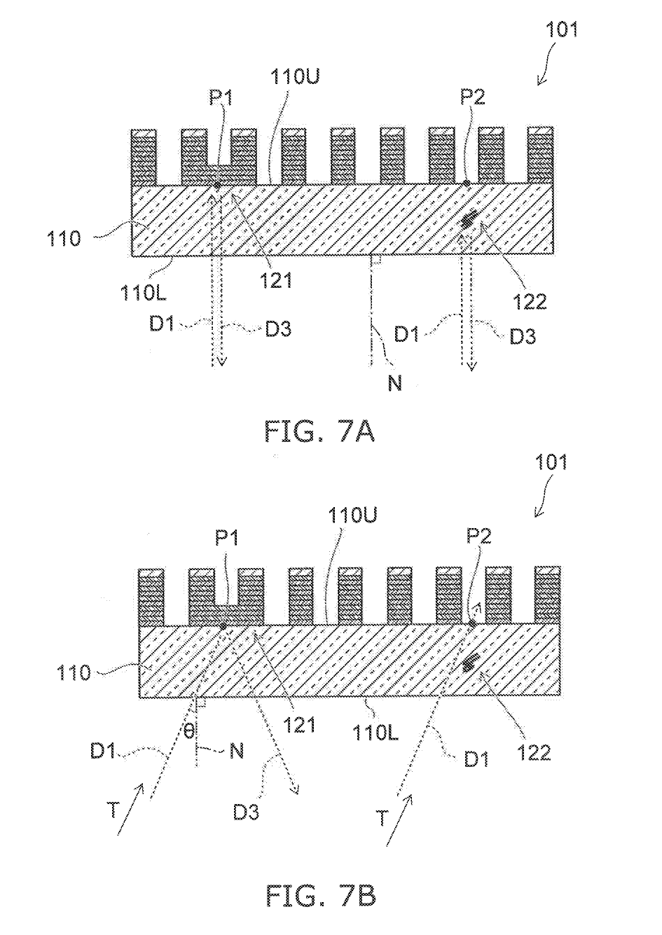

FIGS. 7A and 7B show the defect inspection method according to the embodiment. FIG. 7A shows a lower side inspection in which DUV is incident on the lower surface of the substrate in the normal direction. FIG. 7B shows a lower side oblique inspection in which DUV is incident on the lower surface of the substrate in a direction oblique to the normal.

In the EUV mask 101 shown in FIGS. 1A and 18B, the substrate 110 is formed from LTEM (low thermal expansion material). LTEM is e.g. a material made of quartz and containing titanium oxide (TiO). Due to this titanium oxide, a streaky defect having a refractive index different from that of the surroundings may occur in quartz. This defect is referred to as “stria”. The stria affects the optical path of DUV. Thus, the stria may be recognized as a defect in the inspection using DUV described in the above first embodiment. However, the stria does not constitute a defect for EUV. Thus, preferably, the stria is distinguished from the film remaining defect 121 and not identified as a defect.

As shown in FIGS. 7A and 7B, in the embodiment, it is assumed that the EUV mask 101 includes a film remaining defect 121 and a stria 122.

First, the upper side inspection (see FIGS. 4A and 4B) and the lower side inspection (see FIGS. 5A and 5B) are performed by the method described in the above first embodiment.

As described above, in the upper side inspection, the film remaining defect 121 is difficult to detect, and the stria 122 is more difficult to detect.

In the lower side inspection, as shown in FIG. 7A, both the film remaining defect 121 and the stria 122 are detected. However, the position of the defect in the thickness direction of the substrate 110 is unknown only by the lower side inspection. Thus, it cannot be determined whether the detected defect is a film remaining defect 121 or a stria 122.

<3> Inspection by DUV Irradiation from the Substrate Side in an Oblique Direction (Lower Side Oblique Inspection)

Next, as shown in FIG. 6, defect inspection is performed by irradiating the EUV mask 101 with DUV from the substrate 110 side in a direction T oblique to the normal N of the lower surface 110L. In this specification, this inspection is referred to as “lower side oblique inspection”.

The controller 16c drives the guide rails 16a and 16b to control the position of the DUV laser light source 13 and the DUV detector 15. Thus, the movable stage 11, the DUV laser light source 13, the DUV half mirror 14, and the DUV detector 15 are placed in a positional relationship satisfying the following requirements (6) and (7).

(6) The DUV laser light D1 emitted from the DUV laser light source 13 is incident on the lower surface 110L of the substrate 110 of the EUV mask 101 in the direction T oblique to the normal N of the lower surface 110L.

(7) The EUV mask 101 reflects the DUV laser light D1 as reflection light D3. The reflection light D3 is incident on the DUV detector 15.

Such placement can be realized as follows. The DUV laser light source 13 and the DUV detector 15 are placed on the opposite sides of the normal N. Furthermore, the inclination angle θ of the DUV laser light D1 with respect to the normal N is made equal to the inclination angle θ of the reflection light D3 with respect to the normal N. In this case, the DUV half mirror 14 is not interposed in the optical path of DUV from the DUV laser light source 13 to the DUV detector 15.

In the placement shown in FIG. 6, the DUV laser light source 13 emits DUV laser light D1. The DUV laser light D1 is incident on the lower surface 110L of the substrate 110 of the EUV mask 101 in the direction T. The reflection light D3 reflected by the EUV mask 101 is detected by the DUV detector 15. Also in this lower side oblique inspection, the DUV laser light D1 is reflected by both the film remaining defect 121 and the stria 122 and detected by the DUV detector 15.

As shown in FIGS. 7A and 7B, the position of the defect in the thickness direction of the substrate 110 can be detected by comparison between the inspection result of the lower side inspection and the inspection result of the lower side oblique inspection. Thus, it can be determined whether the detected defect is a film remaining defect 121 or a stria 122.

More specifically, in the lower side inspection shown in FIG. 7A, it is assumed that a defect is detected when the DUV laser light D1 is emitted so as to reach the position P1 on the upper surface 110U of the substrate 110 and when the DUV laser light D1 is emitted so as to reach the position P2 on the upper surface 110U of the substrate 110. In the lower side oblique inspection shown in FIG. 7B, it is assumed that a defect is detected when the DUV laser light D1 Is emitted so as to reach the position P1, and that no defect is detected when the DUV laser light D1 is emitted so as to reach the position P2. In this case, it is considered that the defect detected at the position P1 is located near the upper surface 110U of the substrate 110. Thus, this defect is likely to be a film remaining defect 121. On the other hand, it is considered that the defect detected at the position P2 in the lower side inspection shown in FIG. 7A is located in the substrate 110. Thus, this defect is likely to be a stria 122. Accordingly, it can be determined whether the detected defect is a film remaining defect 121 or a stria 122.

Next, the effect of the embodiment is described.

According to the embodiment, the stria 122 can be excluded from the detected defects. The stria 122 does not constitute a defect in EUV exposure. Thus, the embodiment enables more accurate inspection.

The configuration, operation, and effect of the embodiment other than the foregoing are similar to those of the above first embodiment.

The position of the stria can be approximately determined by inspecting the substrate 110 before forming the multilayer film 112. Thus, in the lower side inspection and the lower side oblique inspection described above, inspection in view of the inspection result of the substrate 110 facilitates determining whether the detected defect is a misdetection due to a stria.

The embodiments described above can realize a defect inspection method and a defect inspection device having high detection accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A defect inspection method comprising:
irradiating an EUV mask including a substrate, a first line-shaped portion, and a second line-shaped portion with deep ultraviolet radiation from a lower surface side of the substrate, the first line-shaped portion being provided on the substrate and including a first layer containing a first material and a second layer containing a second material, the first layer and the second layer being stacked in the first line-shaped portion, and the second line-shaped portion being provided on the substrate, spaced from the first line-shaped portion, and including a first layer containing the first material and a second layer containing the second material, the first layer and the second layer being stacked in the second line-shaped portion; and
detecting reflection light of the deep ultraviolet radiation.

2. The method according to claim 1, wherein the EUV mask includes a film remaining defect placed between the first line-shaped portion and the second line-shaped portion, being in contact with the substrate, and including a first layer containing the first material and a second layer containing the second material.

3. A defect inspection method comprising:
a first irradiating an inspection target including a substrate and a pattern structure body provided on the substrate with inspection light from a lower surface side of the substrate along a first direction and to detect reflection light of the inspection light; and
a second irradiating the inspection target with inspection light from the lower surface side of the substrate along a second direction crossing the first direction and to detect reflection light of the inspection light.

4. The method according to claim 3, wherein
the inspection target is an EUV mask,
the pattern structure body includes a first line-shaped portion and a second line-shaped portion, the first line-shaped portion including a first layer containing a first material and a second layer containing a second material, the first layer and the second layer being stacked in the first line-shaped portion, and the second line-shaped portion being spaced from the first line-shaped portion and including a first layer containing the first material and a second layer containing the second material, the first layer and the second layer being stacked in the second line-shaped portion, and
the Inspection light is deep ultraviolet radiation.

5. The method according to claim 4, wherein
the EUV mask includes a film remaining defect placed between the first line-shaped portion and the second line-shaped portion, being in contact with the substrate, and including a first layer containing the first material and a second layer containing the second material, and
the substrate is made of a low thermal expansion material.

6. A defect inspection device comprising:
a stage configured to hold an inspection target including a substrate and a pattern provided on the substrate so as to expose at least part of a lower surface of the substrate;
a light source configured to irradiate the lower surface of the substrate with inspection light;
a detector configured to detect the inspection light reflected by the inspection target; and
a moving device configured to move the light source and the detector so as to change incident direction of the inspection light with respect to the lower surface.

7. The device according to claim 6, wherein
the inspection target is an EUV mask,
the pattern includes a first line-shaped portion and a second line-shaped portion, the first line-shaped portion including a first layer containing a first material and a second layer containing a second material, the first layer and the second layer being stacked in the first line-shaped portion, and the second line-shaped portion being spaced from the first line-shaped portion and including a first layer containing the first material and a second layer containing the second material, the first layer and the second layer being stacked in the second line-shaped portion, and
the inspection light is deep ultraviolet radiation.
